(19) United States
(12) Patent Application Publication
(10) Pub. No.: US 2023/0334527 A1
(43) Pub. Date: Oct. 19, 2023

(54) SYSTEM AND METHOD FOR BODY PARAMETERS-SENSITIVE FACIAL TRANSFER IN AN ONLINE FASHION RETAIL ENVIRONMENT

(71) Applicant: Myntra Designs Private Limited, Bangalore (IN)

(72) Inventor: Mohak Kumar Sukhwani, Varanasi (IN)

(21) Appl. No.: 17/832,364

(22) Filed: Jun. 3, 2022

(30) Foreign Application Priority Data
Apr. 13, 2022 (IN) 202241021964

(51) Int. Cl. G06Q 30/02; G06T 7/50; G06T 7/10; G06T 7/70; G06T 7/90; G06T 19/00; G06V 40/10; G06V 10/762

(52) U.S. Cl. CPC G06Q 30/0269; G06T 7/50; G06T 7/10; G06T 7/70; G06T 7/90; G06T 19/00; G06V 40/10; G06V 10/762; G06T 2207/30201; G06T 2207/20084; G06T 2210/16

(57) ABSTRACT

A system for body parameters-sensitive facial transfer in a fashion retail environment using one or more deep fake neural networks is presented. The system includes a data module configured to receive a plurality of target objects, a target body parameter estimator configured to estimate a target 3D body shape, a target clustering module configured to create a plurality of target body type clusters, a subject body shape module configured to receive information corresponding to a 3D body shape of a subject, a body parameter matching module configured to identify a target body shape substantially similar to the subject 3D body shape, and a facial transfer module configured to perform facial transfer of the subject onto a target object corresponding to the identified target body shape based on one or more deep fake neural networks to generate an output object. A related method is also presented.

### PRIORITY STATEMENT

The present application hereby claims priority to Indian patent application number 202241021964 filed on 13 Apr. 2022, the entire contents of which are hereby incorporated herein by reference.

### BACKGROUND

Embodiments of the present invention generally relate to systems and methods for body parameters-sensitive facial transfer in an online fashion retail environment, and more particularly to systems and methods for body parameters-sensitive facial transfer using one or more deep fake models in an online fashion platform.

Online shopping (e-commerce) platforms for fashion items, supported in a contemporary Internet environment, are well known. Shopping for clothing items online via the Internet is growing in popularity because it potentially offers shoppers a broader range of choices of clothing in comparison to earlier off-line boutiques and superstores.

Typically, most fashion e-commerce platforms show catalog images with human models wearing the clothing items. The models are shot in various poses and the images are cataloged on the e-commerce platforms. There is limited scope for fashion personalization on current fashion e-commerce platforms. Fashion personalization in e-commerce platforms has been primarily focused on virtual trying rooms which require bulky camera setups and background constraints. Further, the virtual try-on technologies are not able to mimic cloth texture, bends, etc. on a human body leading to prominent artifacts visible on the human body. However, current fashion e-commerce platforms do not provide for personalized fashion catalogs where the end-user is the fashion model on the e-commerce platform. Moreover, it may be desirable to provide personalized advertisements to potential customers for fashion e-commerce platforms.

Therefore, there is a need for systems and methods that enable fashion personalization and/or personalized marketing for e-commerce fashion platforms.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for body parameters-sensitive facial transfer in a fashion retail environment is presented. The system includes a data module configured to receive a plurality of target objects corresponding to a plurality of models wearing one or more garments. The system further includes a target body parameter estimator configured to estimate a target three-dimensional (3D) body shape under the one or more garments from a target object for each model of the plurality of models. The system moreover includes a target clustering module configured to create a plurality of target body type clusters based on the plurality of target 3D body shapes estimated by the target body parameter estimator. The system further includes a subject body shape module configured to receive information corresponding to a 3D body shape of a subject. The system furthermore includes a body parameter matching module configured to identify, from the plurality of target body type clusters, a target body shape substantially similar to the subject 3D body shape. The system further includes a facial transfer module configured to perform facial transfer of the subject onto a target object corresponding to the identified target body shape based on one or more deep fake neural networks to generate an output object.

According to another example embodiment, a system for body parameters-sensitive facial transfer in a fashion retail environment is presented. The system includes a memory storing one or more processor-executable routines and a processor communicatively coupled to the memory. The processor is configured to execute the one or more processor-executable routines to receive a plurality of target objects corresponding to a plurality of models wearing one or more garments; estimate a target three-dimensional (3D) body shape under the one or more garments from a target object for each model of the plurality of models; create a plurality of target body type clusters based on the plurality of target estimated 3D body shapes; receive information corresponding to a 3D body shape of a subject; identify, from the plurality of target body type clusters, a target body shape substantially similar to the subject 3D body shape; and perform facial transfer of the subject onto a target object corresponding to the identified target body shape based on one or more deep fake neural networks to generate an output object.

According to another example embodiment, a method for body parameters-sensitive facial transfer in a fashion retail environment is presented. The method includes receiving a plurality of target objects corresponding to a plurality of models wearing one or more garments; estimating a target three-dimensional (3D) body shape under the one or more garments from a target object for each model of the plurality of models; creating a plurality of target body type clusters based on the plurality of target estimated 3D body shapes; receiving information corresponding to a 3D body shape of a subject; identifying, from the plurality of target body type clusters, a target body shape substantially similar to the subject 3D body shape; and performing facial transfer of the subject onto a target object corresponding to the identified target body shape based on one or more deep fake neural networks to generate an output object.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating an example system for body parameters-sensitive facial transfer in a fashion retail environment, according to some aspects of the present description,

FIG. 2 is a block diagram illustrating an example body parameter estimator, according to some aspects of the present description,

FIG. 3 illustrates an example workflow of a body parameter estimator, according to some aspects of the present description,

FIG. 4 illustrates an example of different target body types in accordance with embodiments of the present description,

FIG. 5A illustrates an example where a subject provides inputs corresponding to body parameters for estimation of corresponding 3D body shape, according to some aspects of the present description,

FIG. 5B illustrates an example where a subject selects a suitable 3D body shape from a selection of body shapes, according to some aspects of the present description,

FIG. 6 is a block diagram illustrating an example system for body parameters-sensitive facial transfer in a fashion retail environment, according to some aspects of the present description,

FIG. 7 illustrates example output 2D images generated based on a single RGB image of the subject, according to some aspects of the present description,

FIG. 8 illustrates a flow chart for body parameters-sensitive facial transfer in a fashion retail environment, according to some aspects of the present description, and

FIG. 9 is a block diagram illustrating an example computer system, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present description provide systems and methods for body parameters-sensitive facial transfer using one or more deep fake models in an online fashion retail environment.

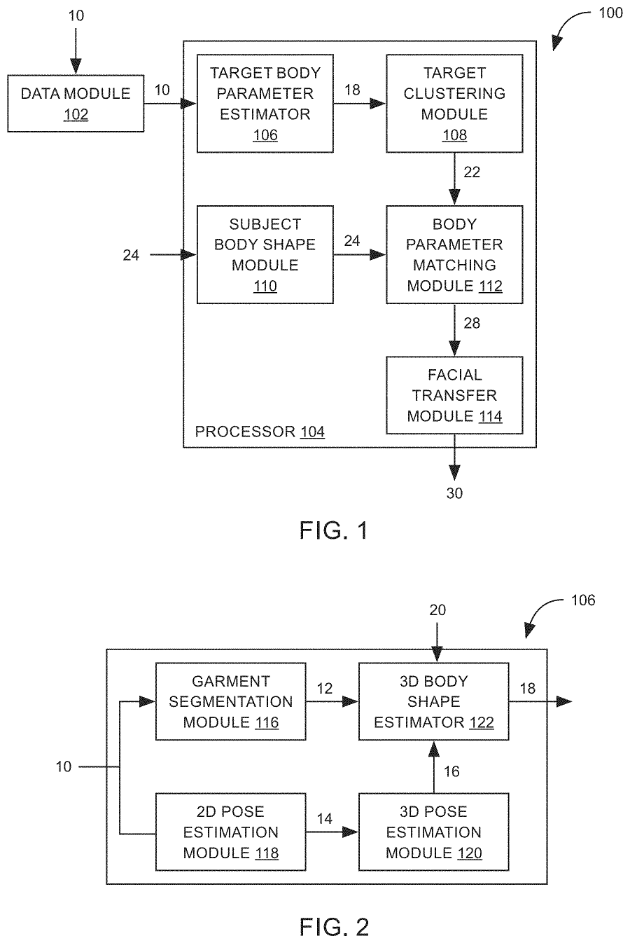

FIG. 1 illustrates an example system 100 for body parameters-sensitive facial transfer in a fashion retail environment. The system 100 includes a data module 102 and a processor 104. The processor 104 includes a target body parameter estimator 106, a target clustering module 108, a subject body shape module 110, a body parameter matching module 112, and a facial transfer module 114. Each of these components is described in detail below. For the purpose of this description, the following embodiments are described with respect to an online fashion retail platform. However, it must be understood that embodiments described herein can be implemented on any e-commerce platform having a portfolio of fashion products.

The data module 102 is configured to receive a plurality of target objects 10 corresponding to a plurality of models wearing one or more garments. Non-limiting examples of a suitable garment may include top-wear, bottom-wear, and the like. In some instances, the plurality of models may be further wearing one or more accessories such as scarves, belts, socks, sunglasses, bags, jewelry, footwear, and the like.

The plurality of target objects 10 may be generated by capturing the target objects for the plurality of models wearing one or more garments using one or more imaging devices. Non-limiting examples of a target object may include a 2D image, a video, a 2D animation, a 3D animation, a 3D image, or combinations thereof. In some embodiments, the plurality of target objects may include a plurality of 2D images, for example, a plurality of 2D RGB images.

In some embodiments, the plurality of target objects 10 may be stored in a target object repository (not shown) either locally (e.g., in a memory coupled to the processor 104) or in a remote location (e.g., cloud storage, offline object repository, and the like) after capturing the target objects. The data module 102 in such instances may be configured to access the target model repository to retrieve the plurality of target objects 10.

The data module 102 is communicatively coupled with a target body parameter estimator 106. The target body parameter estimator 106 is configured to estimate a target three-dimensional (3D) body shape under the one or more garments from a target object for each model of the plurality of models. In some embodiments, the target body parameter estimator 106 is configured to estimate the target 3D body shape for each model of the plurality of models based on a corresponding RGB image of a model wearing the one or more garments.

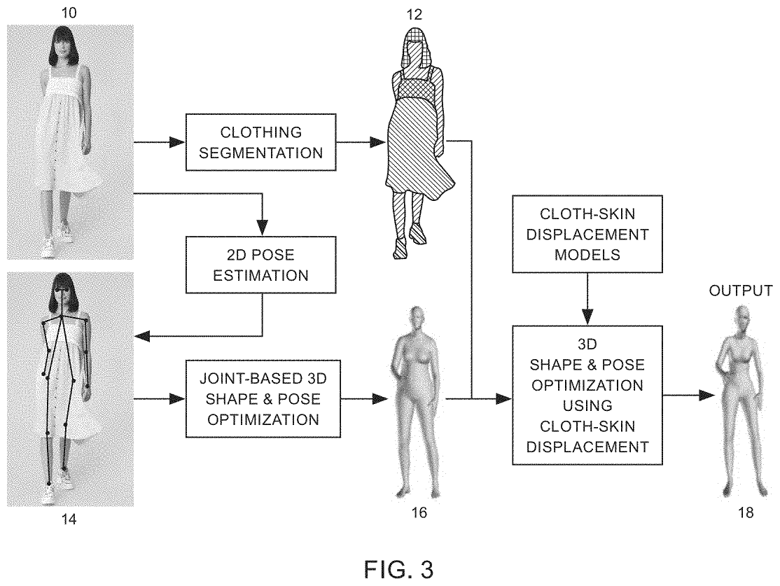

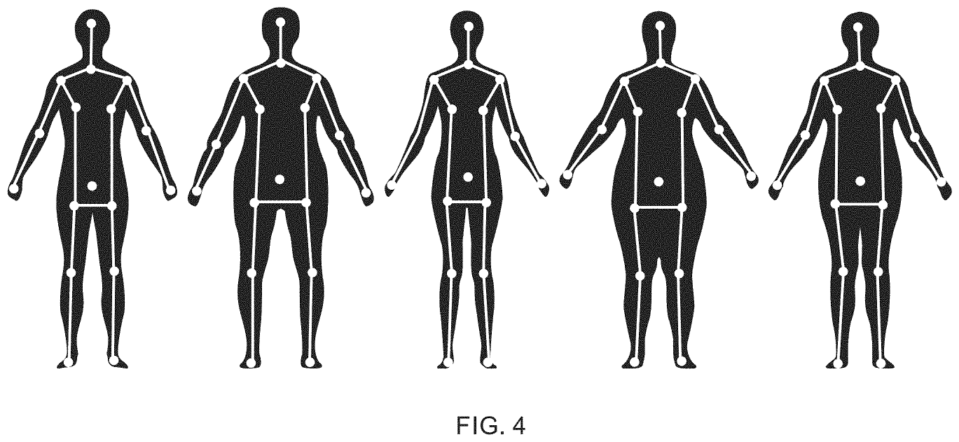

The target body parameter estimator 106 is configured to estimate the target 3D body shape using one or more suitable models. In some embodiments, the target body parameter estimator 106 is configured to estimate the target 3D body shape using one or more cloth displacement models. The manner of operation of the target body parameter estimator 106 is described in detail with reference to FIG. 2. As shown in FIG. 2, the target body parameter estimator 106 includes a garment segmentation module 116, a 2D pose estimation module 118, a 3D pose estimation module 120, and a 3D body shape estimator 122. Each of these components is described in detail below with reference to FIGS. 2 and 3.

The garment segmentation module 116 is configured to generate a plurality of garment segments 12 for each target object of the plurality of target objects 10. The 2D pose estimation module 118 is configured to estimate a 2D pose 14 for each target object 10. The 3D pose estimation module 120 is further configured to identify a plurality of joints from the estimated 2D pose 14 for each target object 10 and estimate a 3D pose 16 based on the plurality of joints. The 3D body shape estimator 122 is furthermore configured to estimate a target body shape 18 for each target object 10 using one or more cloth-skin displacement models 20, based on the plurality of garment segments 12 and the estimated 3D pose 16.

Referring again to FIG. 1, the system 100 further includes a target clustering module 108. The target clustering module 108 is configured to create a plurality of target body type clusters 22 based on the plurality of target 3D body shapes 18 estimated by the target body parameter estimator 106. The target clustering module 108 is configured to create the plurality of target body type clusters 22 based on pre-defined types based on body shape parameters. Non-limiting examples of target body types may include hourglass, round, pear, rectangle, triangle, inverted triangle, and the like. FIG. 4 illustrates an example of different target body types in accordance with embodiments of the present description.

The target body parameter estimator 106 is configured to estimate one or more body parameters for each target body shape of the plurality of target body shapes. Non-limiting examples of body parameters include stature, crotch length, arm length, neck girth, chest/bust girth, under bust girth, waist girth, hip girth, and the like. The target clustering module 108 is further configured to determine a body type for each target body shape of the plurality of target body shapes based on the estimated one or more body parameters. The target clustering module 108 is further configured to create the plurality of target body clusters 22 based on the determined target body types.

The target body parameter estimator 106 may be further configured to estimate one or more body parameters comprising skin tone and the like. In such embodiments, the target clustering module 108 may be further configured to create the plurality of target body type clusters 22 based on the plurality of target 3D body shapes and the one or more body parameters. In some embodiments, the target clustering module 108 may be further configured to create the plurality of target body type clusters 22 based on fashion sense, personality, geography (north/south/east style wear), individual style selection (from past history), and the like.

In some embodiments, the target clustering module 108 is communicatively coupled with the target body parameter estimator 106 and configured to receive the plurality of target body shapes 18 directly. In some other embodiments, the plurality of target body shapes 18 estimated by the target body parameter estimator 106 may be stored in a target body shape repository (not shown) either locally (e.g., in a memory coupled to the processor 104) or in a remote location (e.g., cloud storage, offline object repository, and the like). The target clustering module 108 in such instances may be configured to access the target body shape repository to retrieve the plurality of target body shapes 18.

Referring again to FIG. 1, the system 100 further includes a subject body shape module 110. The subject body shape module 110 is configured to receive information corresponding to a 3D body shape of a subject 24. The term “subject” as used herein may refer to a customer browsing the online retail platform, a potential customer for whom a customized advertisement is generated, or a social media influencer.

The subject body shape module 110 is configured to receive the information corresponding to the 3D body shape of the subject 24 based on information provided by the subject, purchase history of the subject, or a two-dimensional (2D) image of the subject. Non-limiting examples of 3D body shapes include hourglass, round, pear, rectangle, triangle, inverted triangle, and the like.

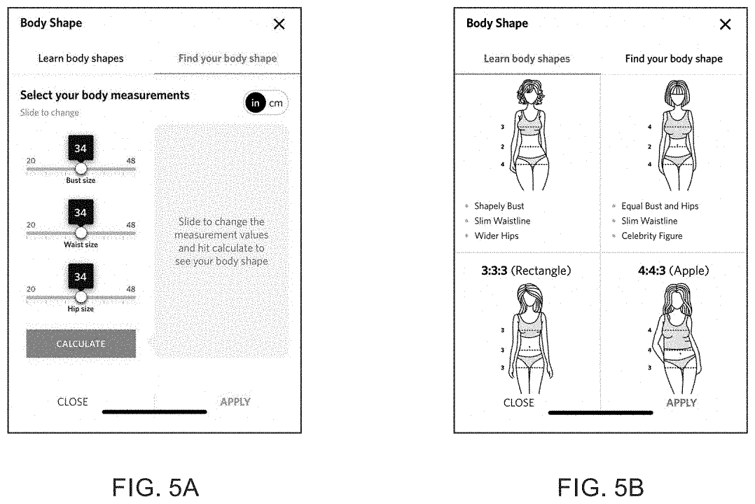

In some embodiments, the subject body shape module 110 is configured to receive the information corresponding to the 3D body shape of the subject 24 based on information provided by the subject. The information provided by the subject may include body parameters (e.g., bust size, waist size, hip size, and the like) based on which the 3D body shape of the subject may be estimated. FIG. 5A illustrates an example where a subject may provide inputs (e.g., using a user interface of an online fashion platform) corresponding to body parameters and the corresponding 3D body shape 24 may be estimated.

In some embodiments, the information provided by the subject may include the 3D body shape directly. In some such embodiments, the subject may select a suitable body shape from a selection of body shapes. FIG. 5B illustrates an example where a subject may select a suitable 3D body shape from a selection of body shapes, e.g., using a user interface of an online fashion platform.

In some embodiments, the 3D body shape for the subject 24 may be estimated based on the purchase history of the subject and the estimated 3D shape may be provided to the subject body shape module 110. In some such embodiments, the body parameters (e.g., bust size, waist size, hip size, and the like) may be estimated based on the purchase history of the subject. The 3D body shape of the subject 24 may be further estimated based on the estimated body parameters.

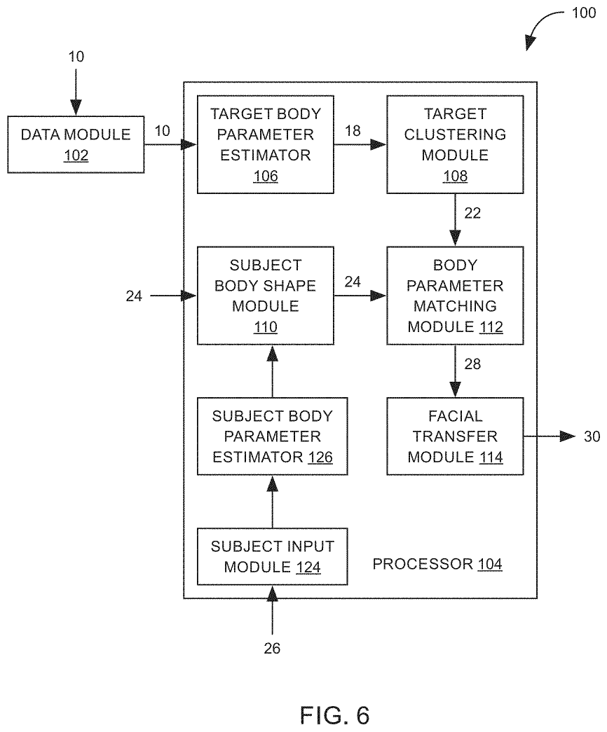

In some embodiments, the 3D body shape for the subject 24 may be estimated based on a 2D image of the subject and the estimated 3D shape may be provided to the subject body shape module 110. This is described further in detail with respect to FIG. 6. As shown in FIG. 6, the system 100 further includes a subject input module 124 configured to receive a (2D) image (e.g., an RGB image) 26 of the subject wearing a garment. The system 100 furthermore includes a subject body parameter estimator 126 configured to estimate the subject 3D body shape 24 under the garment from the 2D image 26 and communicate the information corresponding to the subject 3D body shape to the subject body shape module 124. The subject body parameter estimator 126 may be configured to estimate the subject 3D body shape using one or more suitable models. In some embodiments, the subject body parameter estimator 126 is configured to estimate the subject 3D body shape 24 using one or more cloth displacement models.

Referring again to FIG. 1, the system 100 further includes a body parameter matching module 112. The body parameter matching module 112 is configured to identify, from the plurality of target body type clusters 20, a target body shape 28 substantially similar to the subject 3D body shape 24.

The facial transfer module 114 is configured to perform facial transfer of the subject onto a target object corresponding to the identified target body shape 28 based on one or more deep fake neural networks to generate an output object 30. The term “deep fake neural networks” refers to machine learning methods used to create deep fakes. The main machine learning methods used to create deep fakes are based on deep learning and involve training generative neural network architectures, such as autoencoders or generative adversarial networks (GANs). Non-limiting examples of the output object 30 include a 2D image, a video, a 2D animation, a 3D animation, a 3D image, or combinations thereof.

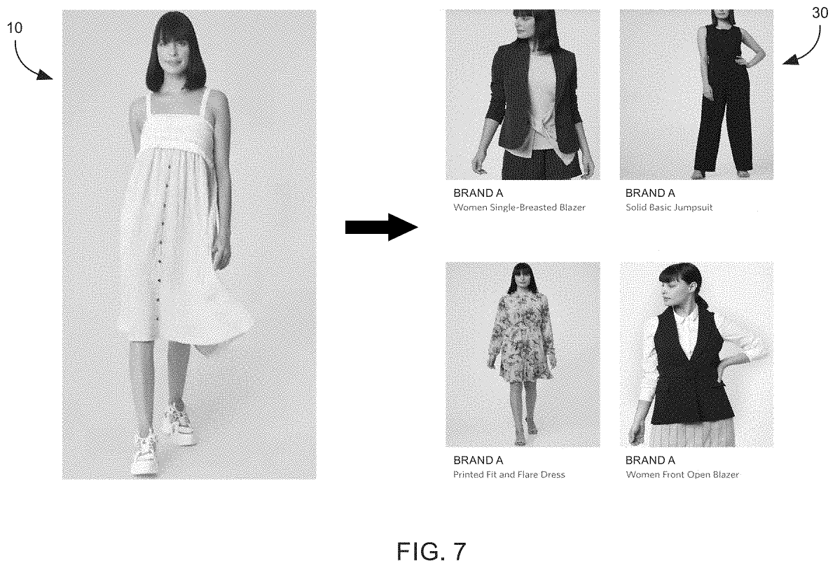

In some embodiments, the output object 30 is a customer's digital twin, allowing for personalized fashion catalogue with customers' real face and body type on garment images. In some embodiments, the output object 30 provides for targeted advertising with a user's face and body type on garment images. In some embodiments, the output object 30 may be employed in tandem with 3D-virtual trail rooms to augment customer experience. FIG. 7 illustrates a virtual catalog containing output 2D images generated using the method described herein based on a single RGB image of the subject/customer.

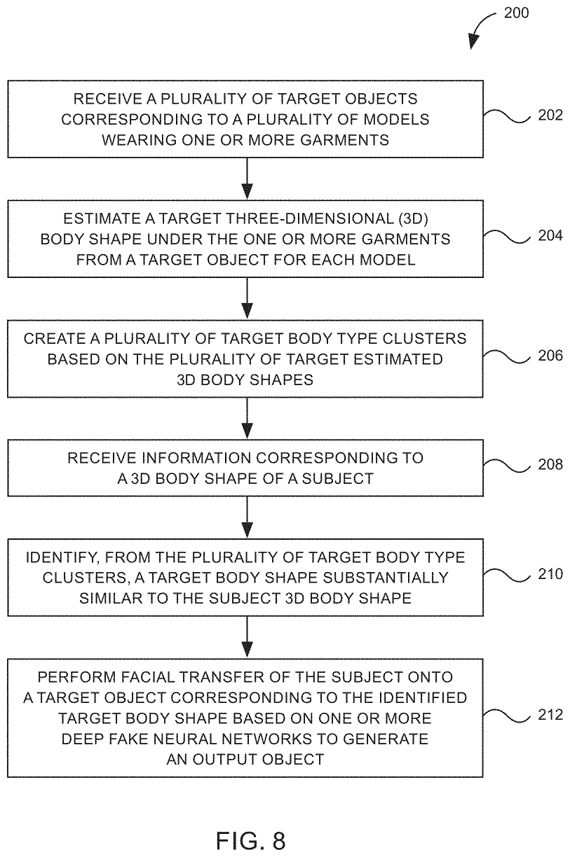

The manner of implementation of the system 100 of FIGS. 1 and 6 is described below in FIG. 8.

FIG. 8 is a flowchart illustrating a method 200 for body parameters-sensitive facial transfer in a fashion retail environment. The method 200 may be implemented using the systems of FIGS. 1 and 6, according to some aspects of the present description. Each step of the method 200 is described in detail below.

The method 200 includes, at step 202, receiving a plurality of target objects corresponding to a plurality of models wearing one or more garments. Non-limiting examples of a suitable garment may include top-wear, bottom-wear, and the like. In some instances, the plurality of models may be further wearing one or more accessories such as scarves, belts, socks, sunglasses, bags, jewelry, footwear, and the like.

The plurality of target objects may be generated by capturing the target objects for the plurality of models wearing one or more garments using one or more imaging devices. Non-limiting examples of a target object may include a 2D image, a video, a 2D animation, a 3D animation, a 3D image, or combinations thereof. In some embodiments, the plurality of target objects may include a plurality of 2D images, for example, a plurality of 2D RGB images.

The method 200 includes, at step 204, estimating a target three-dimensional (3D) body shape under the one or more garments from a target object for each model of the plurality of models. The target 3D body shape may be estimated based on a corresponding RGB image of a model wearing the one or more garments, in some embodiments.

In some embodiments, the step 204 of generating a plurality of garment segments for each target object includes estimating a 2D pose for each target object; identifying a plurality of joints from the estimated 2D pose for each target object, and estimating a 3D pose based on the plurality of joints; and estimating a target body shape for each target object using one or more cloth-skin displacement models, based on the plurality of garment segments and the estimated 3D pose.

As step 206, the method 200 includes creating a plurality of target body type clusters based on the plurality of target estimated 3D body shapes. The plurality of target body type clusters 22 may be created based on pre-defined body types based on body shape parameters. Non-limiting examples of body parameters include stature, crotch length, arm length, neck girth, chest/bust girth, under bust girth, waist girth, hip girth, and the like Non-limiting examples of target body types may include hourglass, round, pear, rectangle, triangle, inverted triangle, and the like.

The method 200 further includes, at step 208, receiving information corresponding to a 3D body shape of a subject. The term “subject” as used herein refers to a customer browsing the online retail platform, a potential customer for whom a customized advertisement is generated, or a social media influencer. Step 208 includes receiving the information corresponding to the 3D body shape of the subject based on information provided by the subject, purchase history of the subject, or a two-dimensional (2D) image of the subject. Non-limiting examples of 3D body shapes include hourglass, round, pear, rectangle, triangle, inverted triangle, and the like.

In some embodiments, the information provided by the subject may include body parameters (e.g., bust size, waist size, hip size, and the like) based on which the 3D body shape of the subject may be estimated (as shown in FIG. 5A). In some embodiments, the information provided by the subject may include the 3D body shape directly. In some such embodiments, the subject may select a suitable body shape from a selection of body shapes (as shown in FIG. 5B).

In some embodiments, the 3D body shape for the subject may be estimated based on the purchase history of the subject. In some such embodiments, the body parameters (e.g., bust size, waist size, hip size, and the like) may be estimated based on the purchase history of the subject. The 3D body shape of the subject may be further estimated based on the estimated body parameters.

In some embodiments, the 3D body shape for the subject may be estimated based on a 2D image of the subject. In some such embodiments, the step 208 includes receiving a (2D) image of the subject wearing a garment and estimating the subject 3D body shape under the garment from the 2D image.

Referring again to FIG. 8, at step 210, the method 200 includes identifying, from the plurality of target body type clusters, a target body shape substantially similar to the subject 3D body shape. The method 200 furthermore includes, at step 212, performing facial transfer of the subject onto a target object corresponding to the identified target body shape based on one or more deep fake neural networks to generate an output object.

The term “deep fake neural networks” refers to machine learning methods used to create deep fakes. The main machine learning methods used to create deep fakes are based on deep learning and involve training generative neural network architectures, such as autoencoders or generative adversarial networks (GANs). Non-limiting examples of the output object include a 2D image, a video, a 2D animation, a 3D animation, a 3D image, or combinations thereof.

In some embodiments, the output object is a customer's digital twin, allowing for personalized fashion catalog with customers' real face and body type on garment images. In some embodiments, the output object provides for targeted advertising with a user's face and body type on garment images. In some embodiments, the output object may be employed in tandem with 3D-virtual trail rooms to augment customer experience. FIG. 7 illustrates a virtual catalog containing output 2D images generated using the method described herein based on a single RGB image of the subject/customer.

Embodiments of the present description provide for systems and methods that enable AI-generated synthetic multi-media fashion personalization. The systems and methods described herein keep clothes constant and digitally reconstruct the human body behind them using deep fake neural networks. The systems and methods described herein may enable (i) immersive, personalized experience that enhances customer engagement, (ii) informed decision making and confidence in shopping, or (iii) cost reduction and increased shopping efficiency.

The systems and methods described herein may be partially or fully implemented by a special purpose computer system created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium, such that when run on a computing device, cause the computing device to perform any one of the aforementioned methods. The medium also includes, alone or in combination with the program instructions, data files, data structures, and the like. Non-limiting examples of the non-transitory computer-readable medium include, but are not limited to, rewriteable non-volatile memory devices (including, for example, flash memory devices, erasable programmable read-only memory devices, or a mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Program instructions include both machine codes, such as those produced by a compiler, and higher-level codes that may be executed by the computer using an interpreter. The described hardware devices may be configured to execute one or more software modules to perform the operations of the above-described example embodiments of the description, or vice versa.

Non-limiting examples of computing devices include a processor, a controller, an arithmetic logic unit (ALU), a digital signal processor, a microcomputer, a field programmable array (FPA), a programmable logic unit (PLU), a microprocessor, or any device which may execute instructions and respond. A central processing unit may implement an operating system (OS) or one or more software applications running on the OS. Further, the processing unit may access, store, manipulate, process and generate data in response to the execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

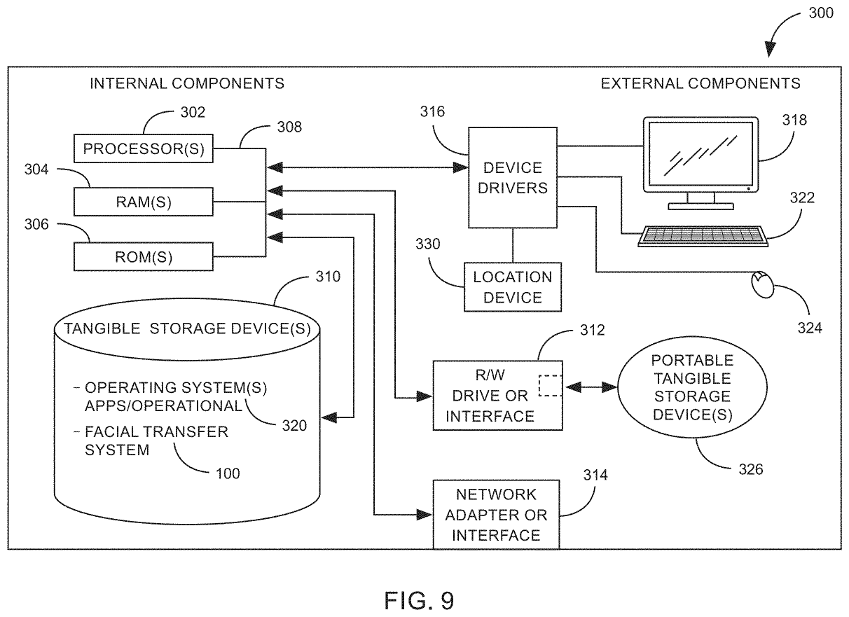

One example of a computing system 300 is described below in FIG. 9. The computing system 300 includes one or more processor 302, one or more computer-readable RAMs 304 and one or more computer-readable ROMs 306 on one or more buses 308. Further, the computer system 308 includes a tangible storage device 310 that may be used to execute operating systems 320 and the facial transfer system 100. Both, the operating system 320 and facial transfer system 100 are executed by processor 302 via one or more respective RAMs 304 (which typically includes cache memory). The execution of the operating system 320 and/or the dynamic resource allocation system by the processor 302, configures the processor 302 as a special-purpose processor configured to carry out the functionalities of the operating system 320 and/or the facial transfer system 100, as described above.

Examples of storage devices 310 include semiconductor storage devices such as ROM 506, EPROM, flash memory or any other computer-readable tangible storage device that may store a computer program and digital information.

Computer system 300 also includes a R/W drive or interface 312 to read from and write to one or more portable computer-readable tangible storage devices 326 such as a CD-ROM, DVD, memory stick or semiconductor storage device. Further, network adapters or interfaces 314 such as a TCP/IP adapter cards, wireless Wi-Fi interface cards, or 3G or 4G wireless interface cards or other wired or wireless communication links are also included in the computer system 300.

In one example embodiment, the facial transfer system 100 may be stored in tangible storage device 310 and may be downloaded from an external computer via a network (for example, the Internet, a local area network or another wide area network) and network adapter or interface 314.

Computer system 300 further includes device drivers 316 to interface with input and output devices. The input and output devices may include a computer display monitor 318, a keyboard 322, a keypad, a touch screen, a computer mouse 324, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

While only certain features of several embodiments have been illustrated and described herein, many modifications and changes will occur to those skilled in the art. It is, therefore, to be understood that the appended claims are intended to cover all such modifications and changes as fall within the scope of the invention and the appended claims.

1. A system for body parameters-sensitive facial transfer in a fashion retail environment, the system comprising:
a data module configured to receive a plurality of target objects corresponding to a plurality of models wearing one or more garments;
a target body parameter estimator configured to estimate a target three-dimensional (3D) body shape under the one or more garments from a target object for each model of the plurality of models;
a target clustering module configured to create a plurality of target body type clusters based on the plurality of target 3D body shapes estimated by the target body parameter estimator;
a subject body shape module configured to receive information corresponding to a 3D body shape of a subject;
a body parameter matching module configured to identify, from the plurality of target body type clusters, a target body shape substantially similar to the subject 3D body shape; and
a facial transfer module configured to perform facial transfer of the subject onto a target object corresponding to the identified target body shape based on one or more deep fake neural networks to generate an output object.

2. The system of claim 1, wherein the subject body shape module is configured to receive the information corresponding to the 3D body shape of the subject based on information provided by the subject, purchase history of the subject, or a two-dimensional (2D) image of the subject.

3. The system of claim 1, further comprising:
a subject input module configured to receive a (2D) image of the subject wearing a garment; and
a subject body parameter estimator configured to estimate the subject 3D body shape under the garment from the 2D image and communicate the information corresponding to the subject 3D body shape to the subject body shape module.

4. The system of claim 1, wherein the target body parameter estimator is further configured to estimate skin tone, and the target clustering module is further configured to create the plurality of target body type clusters based on the plurality of target 3D body shapes and the skin tone.

5. The system of claim 1, wherein the target body parameter estimator comprises:
a garment segmentation module configured to generate a plurality of garment segments for each target object;
a 2D pose estimation module configured to estimate a 2D pose for each target object;
a 3D pose estimation module configured to identify a plurality of joints from the estimated 2D pose for each target object, and estimate a 3D pose based on the plurality of joints; and
a 3D body shape estimator configured to estimate a target body shape for each target object using one or more cloth-skin displacement models, based on the plurality of garment segments and the estimated 3D pose.

6. The system of claim 1, wherein the output object comprises a 2D image, a video, a 2D animation, a 3D animation, a 3D image, or combinations thereof.

7. The system of claim 1, wherein the subject comprises a customer on the fashion retail environment or a social media influencer for the fashion retail environment.

8. A system for body parameters-sensitive facial transfer in a fashion retail environment, the system comprising:
a memory storing one or more processor-executable routines; and
a processor communicatively coupled to the memory, the processor configured to execute the one or more processor-executable routines to:
receive a plurality of target objects corresponding to a plurality of models wearing one or more garments;
estimate a target three-dimensional (3D) body shape under the one or more garments from a target object for each model of the plurality of models;
create a plurality of target body type clusters based on the plurality of target estimated 3D body shapes;
receive information corresponding to a 3D body shape of a subject;
identify, from the plurality of target body type clusters, a target body shape substantially similar to the subject 3D body shape; and
perform facial transfer of the subject onto a target object corresponding to the identified target body shape based on one or more deep fake neural networks to generate an output object.

9. The system of claim 8, wherein the processor is configured to execute the one or more processor-executable routines to receive the information corresponding to the 3D body shape of the subject based on information provided by the subject, purchase history of the subject, or a two-dimensional (2D) image of the subject.

10. The system of claim 8, wherein the processor is further configured to execute the one or more processor-executable routines to receive a (2D) image of the subject wearing a garment and estimate the subject 3D body shape under the garment from the 2D image.

11. The system of claim 8, wherein the processor is further configured to execute the one or more processor-executable routines to estimate skin tone, and create the plurality of target body type clusters based on the plurality of target 3D body shapes and the skin tone.

12. The system of claim 8, wherein the processor is further configured to execute the one or more processor-executable routines to:
generate a plurality of garment segments for each target object;
estimate a 2D pose for each target object;
identify a plurality of joints from the estimated 2D pose for each target object, and estimate a 3D pose based on the plurality of joints; and
estimate a target body shape for each target object using one or more cloth-skin displacement models, based on the plurality of garment segments and the estimated 3D pose.

13. The system of claim 8, wherein the output object comprises a 2D image, a video, a 2D animation, a 3D animation, a 3D image, or combinations thereof.

14. A method for body parameters-sensitive facial transfer in a fashion retail environment, the method comprising:
receiving a plurality of target objects corresponding to a plurality of models wearing one or more garments;
estimating a target three-dimensional (3D) body shape under the one or more garments from a target object for each model of the plurality of models;
creating a plurality of target body type clusters based on the plurality of target estimated 3D body shapes;
receiving information corresponding to a 3D body shape of a subject;
identifying, from the plurality of target body type clusters, a target body shape substantially similar to the subject 3D body shape; and
performing facial transfer of the subject onto a target object corresponding to the identified target body shape based on one or more deep fake neural networks to generate an output object.

15. The method of claim 14, comprising receiving the information corresponding to the 3D body shape of the subject based on information provided by the subject, purchase history of the subject, or a two-dimensional (2D) image of the subject.

16. The method of claim 14, further comprising receiving a (2D) image of the subject wearing a garment and estimating the subject 3D body shape under the garment from the 2D image.

17. The method of claim 14, further comprising estimating skin tone and creating the plurality of target body type clusters based on the plurality of target 3D body shapes and the skin tone.

18. The method of claim 14, further comprising:
generating a plurality of garment segments for each target object;
estimating a 2D pose for each target object;
identifying a plurality of joints from the estimated 2D pose for each target object, and estimating a 3D pose based on the plurality of joints; and
estimating a target body shape for each target object using one or more cloth-skin displacement models, based on the plurality of garment segments and the estimated 3D pose.

19. The method of claim 14, wherein the output object comprises a 2D image, a video, a 2D animation, a 3D animation, a 3D image, or combinations thereof.

20. The method of claim 14, wherein the subject comprises a customer on the fashion retail environment or a social media influencer for the fashion retail environment.
